(19) United States
(12) Patent Application Publication
(10) Pub. No.: US 2017/0066361 A1
(43) Pub. Date: Mar. 9, 2017

(54) SEPARABLE SUPPORT APPARATUS FOR HOUSE OF CAMPING VEHICLE

(71) Applicant: Gwang Bin AHN, Bucheon-si (KR)

(72) Inventor: Gwang Bin AHN, Bucheon-si (KR)

(21) Appl. No.: 15/098,743

(22) Filed: Apr. 14, 2016

(30) Foreign Application Priority Data
Apr. 14, 2015 (KR) 10-2015-0052195

(51) Int. Cl. B60P 3/32; B60P 7/08

(52) U.S. Cl. CPC B60P 3/32; B60P 7/0807

(57) ABSTRACT

The present disclosure provides a separable support apparatus which may be easily removed from a house body in a drive mode, and may be easily coupled to the house body to support the house body on the ground in a parking mode. To the end, the separable support apparatus includes an upper support; a mover disposed above the upper support; a lower support disposed under the upper support, wherein the lower support is configured to be drawn-in/out into/from the upper support via a moving force of the mover; a house body side member secured to a corner face of the house body; and an upper support side member secured to the upper support, wherein upper support side member is positioned at a corresponding level to the house body side member.

### CROSS-REFERENCE TO RELATED APPLICATION

This application claims the benefit of Korean patent application no. 10-2015-0052195 filed on Apr. 14, 2015, the entire content of which is incorporated herein by reference for all purposes as if fully set forth herein.

### BACKGROUND

Field of the Present Disclosure

The present disclosure relates to a separable support apparatus for a house of a camping vehicle. More particularly, the present disclosure relates to a separable support apparatus which may be removed from a house body in a drive mode of a camping vehicle, and may be coupled to the house body to support the house body on the ground in a parking mode of a camping vehicle for a camping activity.

Discussion of the Related Art

Generally, with much available leisure time, peoples go camping, for example, to a sea or river or mountain. Recently, for camping outdoors, a camping vehicle with a loaded house body thereon appears. The house body may have therein a bed, kitchen, and room.

With the conventional camping vehicle, the house body may be integral with the vehicle or may be separable from the vehicle. In a latter type, the house body is loaded on a loading deck of the vehicle in a drive mode, and then is unloaded from the vehicle in a parking mode for a camping activity. In this connection, for supporting the house body on the ground, a support apparatus is necessary to unload the house body from the vehicle and support the house body on the ground.

A conventional support apparatus may be provided at a front and/or rear portion on both sides of the house body. In a drive mode of the vehicle, a lower support is drawn into an upper support to prevent the apparatus from disturbing driving of a driver. In a parking mode, the lower support is drawn out downwards from the upper support to support the house body on the ground.

However, the conventional support apparatus for the house body of the camping vehicle may protrude outwardly from the both side faces of the house body. Thus, in a drive mode of the vehicle, the separable support apparatus may collide with another vehicle or form a scratch or damage in a parked another vehicle.

Further, the conventional support apparatus for the house body of the camping vehicle secured to the house body in the drive mode of the vehicle may increase a dimension of the camping car to limit a rotation radius of the driving vehicle. Of course, the conventional support apparatus for the house body of the camping vehicle secured to the house body in the drive mode of the vehicle may increase a total weight of the house body.

For this reason, a Korean utility model registration No. 20-0333430 discloses a camping vehicle wherein a house body is loaded on a loading deck and unloaded from the deck using a house body support apparatus. The house body support apparatus is configured by symmetrically extending both side faces of the house body downwards below the loading deck where the extension portions are hollow and four at corners of the body respectively, and by inserting support structures at the corners into the hollow extensions respectively, where the support structures ascend or descend, wherein in a lowered state, the support structures support the house body on the ground.

However, in the above document, the house body is removed from the loading deck of the vehicle, and the support apparatus for the house body is not still removed from the house body. Thus, this support apparatus may cause the same problem as mentioned above.

To be specific, this support apparatus may not protrude outwards from the both side faces of the house body because the support structures installed at the corners of the house body vertically move. However, this support apparatus is embedded in the house body. Thus, this configuration may limit the support apparatus of the type in the above prior art document in terms of its applications to various types of camping cars.

Further, since the support structures of the support apparatus of the type in the above prior art document are embedded in the house body at the corners of the house body respectively, the lower ends of the support structures may be exposed as viewed from the below, in other words, may protrude downwards. Thus, the lower ends may collide with projected road portions. This may be the case especially when the vehicle runs on a non-paved road with an uneven surface state. This may lead to damaged support structures.

Prior art documents are as follows: Korean utility model registration number 20-0333430; Korean utility model registration number 20-0293740.

This “Background” section is provided for background information only. The statements in this “Background” section are not an admission that the subject matter disclosed in this “Background” section constitutes prior art to the present disclosure, and no part of this “Background” section may be used as an admission that any part of this application, including this “Background” section, constitutes prior art to the present disclosure.

### SUMMARY

Considering the above, the present disclosure provides a separable support apparatus which may be easily removed from a house body in a drive mode of a camping vehicle to avoid collision between the apparatus and another vehicle, and may be easily coupled to the house body to support the house body on the ground in a parking mode of a camping vehicle for a camping activity.

One aspect of the present disclosure provides a separable support apparatus for supporting a house body loaded or unloaded onto or from a loading deck of a camping vehicle, the apparatus comprising: an upper support; a mover disposed above the upper support; a lower support disposed under the upper support, wherein the lower support is configured to be slidably drawn-in/out into/from the upper support via a moving force of the mover, wherein in the drawing-out downwards state thereof, the lower support supports the house body on the ground; a house body side member secured to a corner face of the house body; and an upper support side member secured to the upper support, wherein upper support side member is positioned at a corresponding level to the house body side member. The house body side member comprises a house-supporting bracket secured to the corner face of the house body, the house-supporting bracket having a first hole formed therein; a protrusion extending from the house-supporting bracket in a perpendicular manner therewith; and a stopper extending from the protrusion with an extension area larger than a cross-sectional area of the protrusion, wherein the protrusion is intervened between the bracket and the stopper. The upper support side member comprises an upper support-coupled bracket secured, at one side, to the upper support and positioned at a corresponding level to the house-supporting bracket, the upper support-coupled bracket having a second hole formed therein, wherein the second hole is positioned at a corresponding level to the first hole; and a hook extending from the upper support-coupled bracket in a parallel manner therewith, the hook defining a cut-away formed therein, the cut-away being open upwards. In an operation, the protrusion of the house body side member is inserted in the cut-away of the hook of the upper support side member and the stopper of the house body side member retains the hook, thereby to enable coupling between the house body side member and the upper support side member, and, thus, to securely support the house body on the ground in a parking mode of the camping vehicle.

In one embodiment, the house-supporting bracket is secured to the corner face of the house body using a screwing coupling.

In one embodiment, the upper support-coupled bracket is secured to the upper support using a welding coupling.

In one embodiment, the cut-away has a linear shape.

In one embodiment, the first hole of the house-supporting bracket and the second hole of the upper support-coupled bracket both are screw-inserted by a bolt, and a free end of the bolt is treaded by a nut.

In accordance with the present disclosure, the separable support apparatus for the house body of the camping vehicle may be easily coupled to or be separated from the house body via the attachment or detachment between the house body side member and upper support side member. This may lead to improved usage and convenience of the separable support apparatus. Further, in the drive mode of the camping vehicle, the separable support apparatus may not contact or collide with another car, which may otherwise lead to a car accident and/or a damage of the separable support apparatus. This may be because the separable support apparatus may be removed from the house body in the drive mode of the camping vehicle.

### BRIEF DESCRIPTION OF THE DRAWINGS

A brief description of each drawing is provided to more fully understand the drawings, which is incorporated in the detailed description of the disclosure.

FIG. 1 illustrates a camping vehicle having a house body loaded thereon in a state when a support apparatus for the house body in accordance with the present disclosure is separated from the house body.

FIG. 2 illustrates a camping vehicle and a house body unloaded from the vehicle in a state when a support apparatus for the house body in accordance with the present disclosure is coupled to the house body.

FIG. 3 illustrates an exploded perspective view of a separable support apparatus for a house of a camping vehicle in accordance with the present disclosure

### DETAILED DESCRIPTIONS

Examples of various embodiments are illustrated in the accompanying drawings and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Hereinafter, a separable support apparatus for a house of a camping vehicle in accordance with the present disclosure will be described in details with reference to attached drawings.

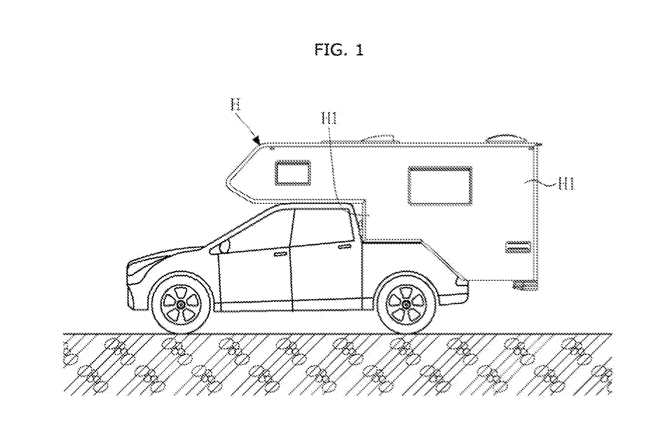

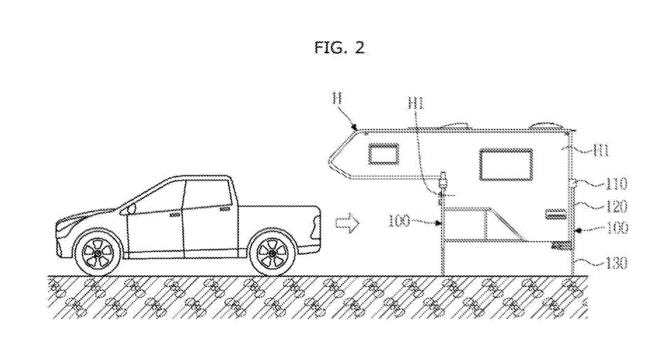

As shown in FIG. 1 and FIG. 2, a camping vehicle in accordance with the present disclosure may have a house body H loaded and unloaded onto and from a loading deck of a camping vehicle. Further, a separable support apparatus 100 for the house body H of the camping vehicle in accordance with the present disclosure may serve to support the house body H on a ground when the house body is unloaded from the loading deck of the camping vehicle onto the ground as shown in FIG. 2. The separable support apparatus 100 may include an upper-disposed mover 110, an upper support 120 disposed under the mover 110, and a lower support 130. The lower support 130 may be configured to slidably be drawn-in/out into/from the upper support 120 respectively via the moving force of the mover 110. The lower support 130 may contact, on its bottom end, the ground to support the house body H on the earth.

As shown in FIG. 1, the camping vehicle may move with the house body H loaded thereon at the loading deck thereof. Otherwise, as shown in FIG. 2, the camping vehicle may park with the house body H unloaded from at the loading deck thereof with the house body being disposed on the ground via the separable support apparatus 100 for the house body H of the camping vehicle in accordance with the present disclosure.

In this connection, details about well-known configurations of the house body, the mover 110, the upper support 120 and the lower support 130, and well-known combinations therebetween are omitted in order not to obscure the main principle of the present disclosure.

In the present disclosure, when the camping vehicle moves with the house body H loaded thereon at the loading deck thereof, the separable support apparatus 100 in accordance with the present disclosure is separated from the house body. Otherwise, when the camping vehicle parks with the house body H unloaded from at the loading deck thereof, the separable support apparatus 100 in accordance with the present disclosure is coupled to the house body H to support the house body H on the ground. Therefore, the separable support apparatus 100 in accordance with the present disclosure may be configured to be attached or detached to the house body H. In order to support the house body H on the ground, the separable support apparatus 100 may include a house body side member 200 secured to a corner face H1 of the house body H, and a upper support side member 300 secured to the upper support 120 and positioned at a corresponding level to the house body side member 200. The house body side member 200 and upper support side member 300 may be configured to be coupled to and be separated from each other as described below.

In this way, when, as shown in FIG. 1, the camping vehicle moves with the house body H loaded thereon at the loading deck thereof, the separable support apparatus 100 may be removed from the house body H. Thus, the separable support apparatus 100 may be prevented from extending outwards or protruding outwards from the house body H to collide with or contact another vehicle in a drive mode.

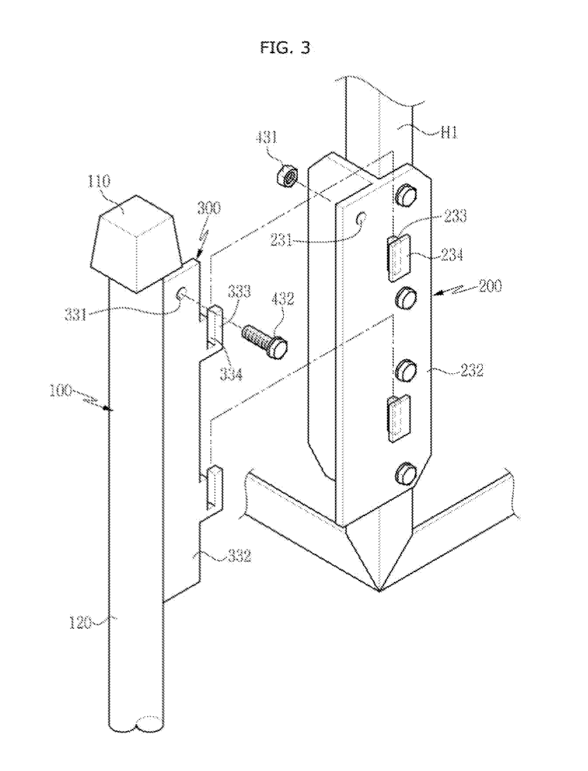

Otherwise, when as shown in FIG. 2 and FIG. 3, the camping vehicle parks with the house body H unloaded from at the loading deck thereof for a camping purpose, the separable support apparatus 100 may be coupled to the house body H, especially, the corner face H1 via a combination of the house body side member 200 and upper support side member 300 to support the house body H on the ground.

As shown in FIG. 3, the separable support apparatus 100 for the house body of the camping vehicle in accordance with the present disclosure may be easily coupled to or be separated from the house body H via the attachment or detachment between the house body side member 200 and upper support side member 300. This may lead to improved usage and convenience of the separable support apparatus. Further, in the drive mode of the camping vehicle, the separable support apparatus may not contact or collide with another car, which may otherwise lead to a car accident and/or a damage of the separable support apparatus. This may be because the separable support apparatus may be removed from the house body in the drive mode of the camping vehicle.

To this end, As shown in FIG. 3, the house body side member 200 of the separable support apparatus 100 may be secure to the H corner face H1 of the house body, for example, via a screwing coupling. The house body side member 200 may include a house-supporting bracket 232 having formed therein a first hole 231. The house body side member 200 may include a protrusion 233 protruding from the house-supporting bracket 232, and a stopper 234 extending from a free end of the protrusion 233 in a parallel with the house-supporting bracket 232 and with an extension area larger than a cross-section area of the protrusion 233.

The upper support side member 300 may include an upper support-coupled bracket 332 positioned at a correspond level to the house-supporting bracket 232. The upper support-coupled bracket 332 may be coupled, at one side, to the upper support 120, for example, via a welding coupling. The upper support-coupled bracket 332 may have a second hole 331 formed therein at positioned at a correspond level to the first hole 231. When the upper support 120 side member 300 is coupled to the house body side member 200, the upper support-coupled bracket 332 is in a tight-contact with the house-supporting bracket 232, and the first and second holes 231 and 331 encounter each other. The upper support side member 300 may include a hook 333 extending from a free end of the upper support-coupled bracket 332 in a coplanar manner. Thus, the hook 333 defines a cut-away 334 to be surrounded with the hook. The cut-away may be linear. However, the present disclosure is not limited thereto. The cut-away 334 may be open upwards. When the upper support side member 300 is coupled to the house body side member 200, the protrusion 233 may be inserted into the cut-away 334.

For an operation of the separable support apparatus 100 for the house body of the camping vehicle in accordance with the present disclosure, the protrusion 233 of the house body side member 200 may be inserted into the cut-away 334 defined by the hook 333 of the upper support side member 300, thereby leading to a combination between the house body side member 200 and the upper support side member 300. In other words, the hook 333 of the upper support side member 300 may be retained by the protrusion 233 of the house body side member 200. In this way, the house body side member 200 with the house-supporting bracket 232 may be coupled to the upper support side member 300 with the upper support-coupled bracket 332.

When the house body side member 200 is coupled to the upper support side member 300, the stopper 234 extending from the protrusion 233 may act to prevent the hook 333 of the upper support side member 300 retained in the protrusion 233 of the house body side member 200 from escaping from the protrusion 233 outwardly. In this way, the secure coupling between the house body side member 200 with the house-supporting bracket 232 and the upper support side member 300 with the upper support-coupled bracket 332 may be firmly maintained.

Otherwise, in order that the upper support side member 300 is disengaged with the house body side member 200, the hook 333 may be pushed upwards to be separated from the protrusion 233. In this way, the disengagement between the house body side member 200 with the house-supporting bracket 232 and the upper support side member 300 with the upper support-coupled bracket 332 may be easily enabled.

Further, after the protrusion 233 of the house body side member 200 is inserted into the cut-away 334 defined by the hook 333 of the upper support side member 300, the first hole 231 of the house-supporting bracket 232 and the second hole 331 of the upper support-coupled bracket 332 both are screw-inserted by a first bolt 431, whose a free end is treaded by a first nut 432. In this way, the secure coupling between the house body side member 200 with the house-supporting bracket 232 and the upper support side member 300 with the upper support-coupled bracket 332 may be further firmly maintained. This may allow the house body H to be securely supported on the ground by the separable support apparatus 100.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A separable support apparatus for supporting a house body loaded or unloaded onto or from a loading deck of a camping vehicle, the apparatus comprising:
an upper support;
a mover disposed above the upper support;
a lower support disposed under the upper support, wherein the lower support is configured to be slidably drawn-in/out into/from the upper support via a moving force of the mover, wherein in the drawing-out downwards state thereof, the lower support supports the house body on the ground;
a house body side member secured to a corner face of the house body; and
an upper support side member secured to the upper support, wherein upper support side member is positioned at a corresponding level to the house body side member,
wherein the house body side member comprises:
a house-supporting bracket secured to the corner face of the house body, the house-supporting bracket having a first hole formed therein;
a protrusion extending from the house-supporting bracket in a perpendicular manner therewith; and
a stopper extending from the protrusion with an extension area larger than a cross-sectional area of the protrusion, wherein the protrusion is intervened between the bracket and the stopper;
wherein the upper support side member comprises:
an upper support-coupled bracket secured, at one side, to the upper support and positioned at a corresponding level to the house-supporting bracket, the upper support-coupled bracket having a second hole formed therein, wherein the second hole is positioned at a corresponding level to the first hole; and
a hook extending from the upper support-coupled bracket in a parallel manner therewith, the hook defining a cut-away formed therein, the cut-away being open upwards,
wherein the protrusion of the house body side member is inserted in the cut-away of the hook of the upper support side member and
the stopper of the house body side member retains the hook, thereby to enable coupling between the house body side member and the upper support side member, and, thus, to securely support the house body on the ground in a parking mode of the camping vehicle.

2. The apparatus of claim 1, wherein the house-supporting bracket is secured to the corner face of the house body using a screwing coupling.

3. The apparatus of claim 1, wherein the upper support-coupled bracket is secured to the upper support using a welding coupling.

4. The apparatus of claim 1, wherein the cut-away has a linear shape.

5. The apparatus of claim 1, wherein the first hole of the house-supporting bracket and the second hole of the upper support-coupled bracket both are screw-inserted by a bolt, and a free end of the bolt is treaded by a nut.
